(19) United States
(12) Patent Application Publication
(10) Pub. No.: US 2006/0248708 A1
(43) Pub. Date: Nov. 9, 2006

(54) Method of forming an antenna on a circuit board

(76) Inventor: Yung-Yu Kuo, Kaohsiung County (TW)

Correspondence Address: BIRCH STEWART KOLASCH & BIRCH, PO BOX 747, FALLS CHURCH, VA, 22040-0747, US

(21) Appl. No.: 11/123,103

(22) Filed: May 6, 2005

(51) Int. Cl. G06K 19/06

(52) U.S. Cl. 29/600; 29/830; 29/846; 343/700 MS; 235/491

(57) ABSTRACT

A method of forming an antenna on a circuit board includes the steps of drilling the circuit board at selected positions to produce a groove having predetermined dimensions; applying carbon powder on all surfaces of the groove; and performing plating over the carbon powder on the groove, so that a metal layer is attached to the surfaces of the groove, and an antenna in the form of a metal layer on the circuit board is completed.

### FIELD OF THE INVENTION

The present invention relates to a method of forming an antenna on a circuit board, and more particularly to a method of forming an antenna on a circuit board without additionally occupying any available space on the circuit board.

### BACKGROUND OF THE INVENTION

FIG. 1 shows the structure of a built-in antenna 12 for a general wireless electronic apparatus. As shown, the antenna 12 is formed by way of etching, printing, or plating a circuit board 11 of the wireless electronic apparatus to form a metal layer on the circuit board 11. The antenna 12 is electrically connected to a control circuit (not shown) of the wireless electronic apparatus, so that a user may use the antenna 12 to transmit or receive packet data over network using the wireless electronic apparatus.

Although the conventional built-in antenna 12 is directly provided on the circuit board 11 to reduce unnecessary troubles in installing a general antenna, it must have an increased area or length to enable better receiving or transmitting efficiency. As a result, the antenna 12 would occupy a big available space or area on the circuit board 11 to increase difficulties in the layout of other circuits on the circuit board 11, and it is impossible to reduce an overall area of the circuit board 11 or miniaturize the wireless electronic apparatus.

Therefore, it is an important issue in the related industrial fields to provide a built-in antenna for wireless electronic apparatus that have limited internal space, so that unnecessary troubles in installing a general antenna can be avoided and no available space on the circuit board would be additionally occupied.

It is therefore tried by the inventor to develop a completely new method for forming an antenna on a circuit board to eliminate drawbacks existed in the conventional built-in antenna for wireless electronic apparatus.

### SUMMARY OF THE INVENTION

A primary object of the present invention is to provide a method of forming an antenna on a circuit board, such that the antenna so formed eliminates unnecessary troubles in installing a general antenna and does not additionally occupy any available space on the circuit board.

To achieve the above and other objects, the method of the present invention for forming an antenna on a circuit board includes the steps of drilling the circuit board at selected positions to produce a groove having predetermined dimensions; applying carbon powder on all surfaces of the groove; and performing plating over the carbon powder on the groove, so that a metal layer is attached to the surfaces of the groove, and an antenna in the form of a metal layer on the circuit board is completed.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional antenna formed on a circuit board;

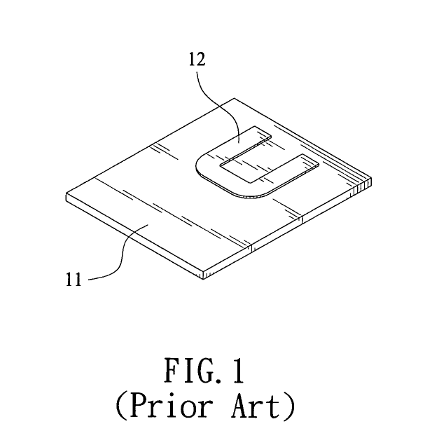

FIG. 2 is a flowchart showing steps included in a method of forming an antenna on a circuit board according to the present invention; and

FIG. 3 is a perspective view of an antenna formed on a circuit board in the method of the present invention.

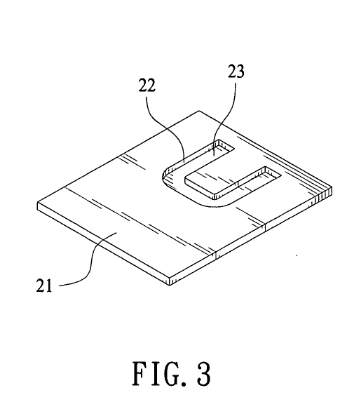

### DETAILED DESCRIPTION OF THE PREFERRED EMBODIMENTS

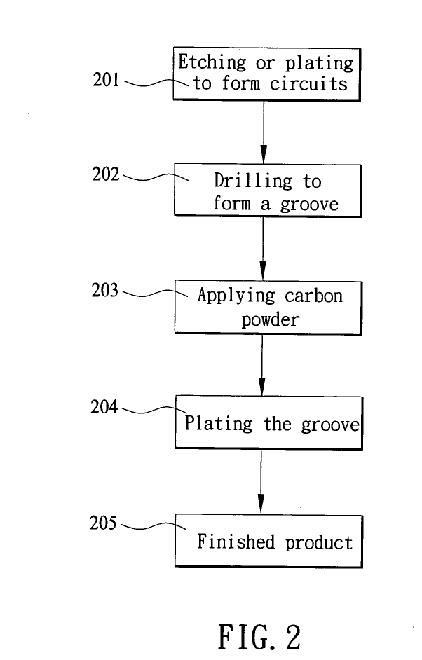

Please refer to FIG. 2 that is a flowchart showing steps included in a method of forming an antenna 22 on a circuit board 21 according to the present invention.

First, the circuit board 21 is etched or plated at selected positions to form predetermined circuits (Step 201).

Then, the circuit board 21 is drilled at predetermined positions to form a groove 23 having predetermined dimensions (Step 202).

Thereafter, carbon powder is applied on all surfaces of the groove 23 (Step 203).

Then, plating is performed over the carbon powder applied on the groove 23, so that a metal layer, such as a copper layer, is attached to the surfaces of the groove 23 to electrically connect to the circuits formed on the circuit board 21 in the Step 201 (Step 204).

Finally, an antenna 22 in the form of a metal layer is completed on the circuit board 21 (Step 205).

The forming of the antenna 22 in the groove 23 on the circuit board 21 in the above-described method not only eliminates unnecessary troubles in installing a general antenna, but also enables the antenna 22 to have a freely increased area or length without additionally occupying any available space on the circuit board 21.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of forming an antenna on a circuit board, comprising the steps of:
(a) Drilling the circuit board at selected positions thereon to produce a groove having predetermined dimensions;
(b) Applying carbon powder on all surfaces of the groove;
(c) Performing plating over the carbon powder on the groove, so that a metal layer is attached to the surfaces of the groove to electrically connect to circuits on said circuit board; and
(d) Completing an antenna in the form of a metal layer on the circuit board.

2. The method of forming an antenna on a circuit board as claimed in claim 1, wherein the metal layer comprises a copper layer.
